(19) United States
(12) Patent Application Publication
(10) Pub. No.: US 2016/0148297 A1
(43) Pub. Date: May 26, 2016

(54) METHOD AND A SYSTEM FOR RECOMMENDING LIMITED CHOICES WHICH ARE PERSONALIZED AND RELEVANT TO A CUSTOMER

(71) Applicants: AJAY KASHYAP, ROORKEE (IN); SURESH VENUGOPALAN SHANKAR, Singapore (SG)

(72) Inventors: AJAY KASHYAP, ROORKEE (IN); SURESH VENUGOPALAN SHANKAR, Singapore (SG)

(21) Appl. No.: 14/613,351

(22) Filed: Feb. 3, 2015

(30) Foreign Application Priority Data
Nov. 24, 2014 (SG) 10201407763U

(51) Int. Cl. G06Q 30/06; G06N 5/04

(52) U.S. Cl. CPC G06Q 30/0631; G06N 5/04

(57) ABSTRACT

A method of recommending limited choices which are personalized and relevant to a customer in real-time, in which steps thereof are implemented by a computer, the method comprising: receiving data across different categories of products; configuring a taste graph based on the received data; calculating a net affinity between any two products in the taste graph and exporting them as taste scores to a taste table; understanding the customer based on context and behavior from different customer information sets; generating scores for the different customer information sets; determining different weightages for each score to calculate a net score associated with each product for the customer; and recommending limited choices which are personalized and relevant to the customer in real-time based on the descending order of the value of the net score associated with the product.

### FIELD OF THE INVENTION

This invention relates to the domain of recommender systems. In specific, the invention relates to a method and system for recommending limited choices which are personalized and relevant to the customer in real-time.

### BACKGROUND OF THE INVENTION

The internet age has information in abundance, and the biggest challenge faced by most users/customers is the explosion of choices due to more and varied sources of information, higher number of devices, increase in real-time data, higher transparency and the rise of social media.

With so much information at their disposal, customers are envisioning a favorable opportunity to select products backed by statistics and data. However, statistics and data alone can themselves lead to a high number of choices or recommendations, and customers must select the most relevant recommendations among them. This may not be easy and may lead to more confusion leading to a decision paralysis. As book titled ‘The Paradox of Choice’ by Dr. Barry Schwartz from Swarthmore College (http://wp.vcu.edu/univ200spencer/wp-content/uploads/sites/4941/2014/08/Paradox-of-Choice.pdf) says: too many choices have led to decision paralysis, postponed moments of reckoning. increased expectations and decreased satisfaction in life.

Hence, a reliable recommendation system that aims to alleviate decision paralysis is need of the hour.

A recommendation service is a computer-implemented service that recommends choices from a database of information. The recommendations are customized to particular items based on information known about them. Recommender systems that provide recommendation service assist customers in selecting choices based on data related to purchases, reviews, browser cookies, likes on social media, common features or similarities between entities etc.

The domain of recommender systems covers the steps of prediction and recommendation and leverages different mathematical methods to solve the problems of finding similarity and ranking in choices presented to customers. The usage of such recommended choices is driven by both objective methods (relevance) and a subjective perception (desirability).

The efficiency of the objective methods is based on algorithms used to determine choices, and there are two main methods to drive recommendations to the customers.

The first method is known as ‘Collaborative Filtering’ in which usage of ratings or actions of other users similar to the user under focus drives the choices. This method assumes that if the user exhibits a behavior similar to others with respect a particular set of items, a similarity measure determines a list of choices for current item based on a similarity rating for the current item. This is known as a user-to-user method for collaborative filtering. A variation of this is known as an item-to-item method for collaborative filtering in which the similarity of the items is computed by leveraging similarity rating of the users.

The second method is known as content-based filtering in which attributes of items under consideration are used to derive similarity and drive recommendations to the user.

Current recommender systems face issues of cold start, i.e., they need substantial user information even before they can start delivering recommendations. Also, they cannot be used to configure delivery of recommendations by holistically understanding the taste of users, i.e., they cannot be trained to increase serendipity, remove biases of location, etc. Also, current recommender systems face issues such as lack of data due to limitations associated with availability, cost or location. There have been some efforts to alleviate the mentioned issues. However, all of them do not address the problem in its entirety and, hence, overlook the underlying advantages.

U.S. Pat. No. 7,672,865 discloses a recommender system implementing a cross-category item-to-item affinity graph. It customizes the graph for taking attributes of entities into consideration while recommending choices to users. However, it fails to alleviate the issues related to lack of data due to limitations associated with availability, cost or location. Further, it also fails to remove biases of location while recommending choices to users.

U.S. Pat. No. 6,266,649 implements an item-to-item graph for cross-category recommendations. It uses collaborative filtering by determining affinity between two items based on number of people purchasing both items. Also, it mentions use of content-based filtering along with collaborative filtering for determining item-to-item mapping. However, it fails to use user's context for selecting personalized and relevant choices for the customer. Also, it fails to alleviate the issues related to lack of data due to limitations associated with availability, cost or location.

A publication titled “Measuring User Similarity Using Electric Circuit Analysis: Application to Collaborative Filtering” by Joonhyuk Yang discloses a technique for measuring user similarity in collaborative filtering using electric circuit analysis. It simulates user-product graph as electrical circuit. Further, using the laws of electric circuit topology, the effective affinity between any two nodes is calculated. However it focuses mostly on product-user matrix, and does not implement the electrical circuit analogy to item-to-item graphs. It also fails to remove biases of location, increasing serendipity etc. by efficient configuration of graph. Further, it fails to incorporate user's context along with behavior for selecting choices for recommendation.

Thus, there exists a need for an improved recommender system for recommending limited, personalized and relevant choices to users without being limited by the above mentioned issues.

### SUMMARY OF THE INVENTION

The present invention provides a method, system and software for recommending personalized, limited and relevant choices to users in real time.

In accordance with methods and systems disclosed in the present invention, raw data related to various entities is obtained from multiple sources of data. The entities could belong to various categories of consumer products such as books, movies, hotels, travel and attractions, events, shopping (fashion, electronics, sports, home), music, TV shows, etc. The raw data for each entity corresponding to one of the categories could include data pertaining to shopping transactions, social media statistics, consumer and expert reviews, loyalty programs, consumer browsing behavior, and product information from various shopping websites.

The raw data is then processed to determine direct affinities, which are measures of instances of co-occurrences between various entities. Direct affinities may be obtained either by making note of consumer behavior or common attributes of relevant entities. Some examples of consumer behavior are number of consumers purchasing both entities, number of people liking both entities on social media, number of people reviewing both entities, etc. Some examples of common attributes include entities catering to specific consumer brackets, price points, etc. Further, various attributes may also be assigned specific weights.

Thereafter, an affinity graph, also known as a taste graph, is now created with entities as nodes and affinities between them as edges. Nodes are added to the taste graph under constraints determined by a taste configurator, which takes care of configuration of graph.

Further, a net affinity between any two nodes in the taste graph is calculated by implementing a net affinity algorithm. In accordance with the net affinity algorithm, an electrical circuit analogy is drawn for the taste graph by considering direct affinities between two nodes as respective conductances. Effective conductance between any two pairs of nodes is then interpreted as net affinity scores between them. The net affinity scores are then exported to a taste table.

A user input in form of context and behavior of the user is received. The context related user input could include information such as location, date and time, weather, person accompanying the user, etc. Behavior related user input could include age, gender, specific preferences, social media likes, reviews, past purchase behavior, feedback on previous recommendations, etc. The user input is then used to determine scores for relevant entities, using the taste table, and a limited number of entities with highest scores are then recommended as choices to the user.

### BRIEF DESCRIPTION OF DRAWINGS

FIG. 1 depicts a data processing system for practicing methods and systems for implementing the present invention.

FIG. 2 illustrates taste configuration of entities in category of movies in accordance with the present invention.

FIG. 3 illustrates taste configuration of entities in category of restaurants in accordance with the present invention.

FIG. 4 illustrates taste graph in accordance an aspect of the present invention.

FIGS. 5 A-D illustrates net affinity calculation algorithm in accordance with the present invention.

FIG. 6 illustrates details of net affinity score calculation in accordance with the present invention.

FIG. 7 is a representation for explaining the components and steps of execution in the data processing system in accordance with an embodiment of the present invention.

### DETAILED DESCRIPTION OF THE INVENTION

Described herein are the methods, computer systems and software for recommending limited, personalized and relevant choices to users in accordance with the present invention. The following detailed description of the invention refers to the accompanying drawings.

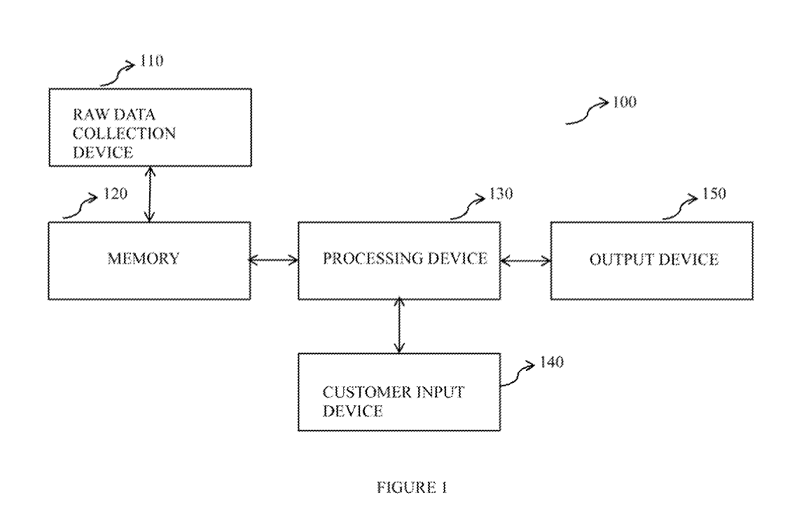

FIG. 1 depicts a block diagram of a recommender system 100 in accordance with one embodiment of the present invention. The system 100 comprises a raw data collection device 110, which collects raw data related to entities and users. The entities could belong to various categories of consumer products including, but not limited to books, movies, hotels, travel and attractions, events, shopping (fashion, electronics, sports, home), music and TV shows. The raw data for each entity corresponding to one of the categories could include data pertaining to shopping transactions, social media statistics, consumer and expert reviews, loyalty programs, consumer browsing behavior and product information from various shopping websites. The raw data collection device 110 could be a computer, central processing unit (CPU), processor, microprocessor, controller enabled with memory or a combination of these. The raw data collection device 110 could further include software or programmed code for enabling raw data collection. Further, the raw data collection device 110 could be connected to a communication network including, but not limited to Internet, Ethernet, Local Area Network (LAN), and Wide Area Network (WAN). The raw data collection device 110 is coupled to memory 120. The raw data collected by the raw data collection device 110 is stored in the memory 120. The received raw data could be stored in a structured or non-structured format in the memory 120. The memory 120 could further store algorithm for receiving data, processing data, set of attributes for data, feedbacks received from the user, user input data, past recommendation results. The memory 120 could be a RAM, ROM, hard disk, server or any other storage memory known in the art. A processing device 130 is coupled to the memory 120 and receives the raw data stored in the memory. The processing device 130 could be a computer, server, processor, CPU, or a combination thereof, enabled with software for implementing the algorithm in accordance with the present invention.

After receiving the raw data from memory 120, the processing device 130 converts this raw data into structured data and determines direct affinity between entities. Direct affinities may be obtained either by making note of consumer behavior or common attributes of relevant entities. Some examples of consumer behavior are number of consumers purchasing both entities, number of people liking both entities on social media, number of people reviewing both entities, etc. Some examples of common attributes include entities catering to specific consumer brackets, price points, genres, popularity, rating, specific consumer brackets, price points, location of availability of the entity, time of release etc. Further, various attributes may also be assigned specific weights. The processing device 130 could also assign weights to various attributes. The processing device 130 further calculates net affinity score between any two nodes in the taste graph using a net affinity algorithm. The processing device 130 then exports the net affinity scores into a taste table, wherein taste table is a tabular representation of pair of entities and net affinity between them.

Customer input device 140 enables the customer to enter data, including but not limited to context information, behavior information, prioritizing filters and feedback on recommendation results. The context related user input may include one or more information related to location, date and time, weather, person accompanying the user, etc. Behavior related user input may include one or more information related to age, gender, specific preferences, social media likes, reviews, past purchase behavior, feedback on previous recommendations, etc.

The customer input device 140 could be a computer, portable computer such as laptop, mobile handset, personal data assistant such as tablet. The customer could further enable the customer input device 140 with software for assisting input of data. The processing device 130 then determines scores for all the relevant entities using the taste table. A list of limited, relevant and personalized choices, i.e. entities for recommendation is then determined by the processing device 130, in decreasing order of values of scores. This list of choices is then provided to the output device 150 for display to the customer. The output device 150 could be display device such as computer, portable computer such as laptop, mobile handset, personal data assistant such as tablet. In many cases, the customer input device may be the same as the customer output device.

Thus, the present invention uses internal and external data sources to take into account factors such as shopping behavior, product likes and dislikes from review websites, social media influences and the current context while recommending choices to the users. Further, it provides highly personalized and relevant choices to users by taking into account both context and behavior of the user. It solves the dilemma of high number of choices available to the user by recommending the most suitable choices to the user.

It is to be noted that the term ‘raw data’ is limited in its context to the invention and may simply mean ‘unprocessed data’, wherein the data is processed such that it can be used directly by the recommender system.

According to one aspect of the present invention, a raw data collection device 110 receives raw data from a plurality of internal and external sources. The raw data could be data related to shopping transactions, social media statistics, consumer and expert reviews, loyalty programs, consumer browsing behavior, product information from various shopping websites. The data related to shopping transactions could be obtained directly from banks, credit card providers or retailers, in form of credit card purchase receipts or sales invoices. Social media statistics could be obtained directly from social media websites such as Facebook, Twitter. LinkedIn etc. Consumer and expert reviews could be obtained from review websites such as Tripadvisor.com, IMDB.com etc. Further, expert reviews could be obtained from expert review websites such as ladyironchef.com. Consumer browsing behavior could be received from browser cookies of various consumers. Product information such as features of products, price, release data etc. could be obtained from e-commerce websites such as Amazon.com, alibaba.com etc. The raw data could further include data related to deals and discounts, from websites such as groupon.com. It is to be noted that special provisions may be made to protect sensitive information related to user identity.

By receiving the raw data, the recommender system 100 aims to capture taste and shopping behavior of consumers, social media influence, attributes of products and context.

The processing device 130 transforms the raw data into structured data to extract relevant information. The structured data could be in tabular format to represent pairs of entities and affinity between them. The attributes could be predefined by the recommender system 100 or could be defined by the user. Also, the attributes could be derived from the received raw data. Further, the structured data could also represent attributes in common between entities from different categories. The structured data could be stored in the memory 120.

According to one aspect of the present invention, the processing device 130 calculates direct affinities between entities, either by making note of consumer behavior or common attributes of entities. The attributes could vary from one category of entities to another. Further, two entities in different categories may share common attributes. For example, a book and a movie could belong to the same genre.

According to one aspect of the present invention, processing device 130 configures a taste graph from the structured data, with entities as nodes and affinity between them as edges. Taste configurator, a component of processing device 130, configures the taste graph. The taste configurator prunes and shapes the taste graph by selectively adding entities based on certain attributes of these entities. This enables better modeling of the consumer's taste.

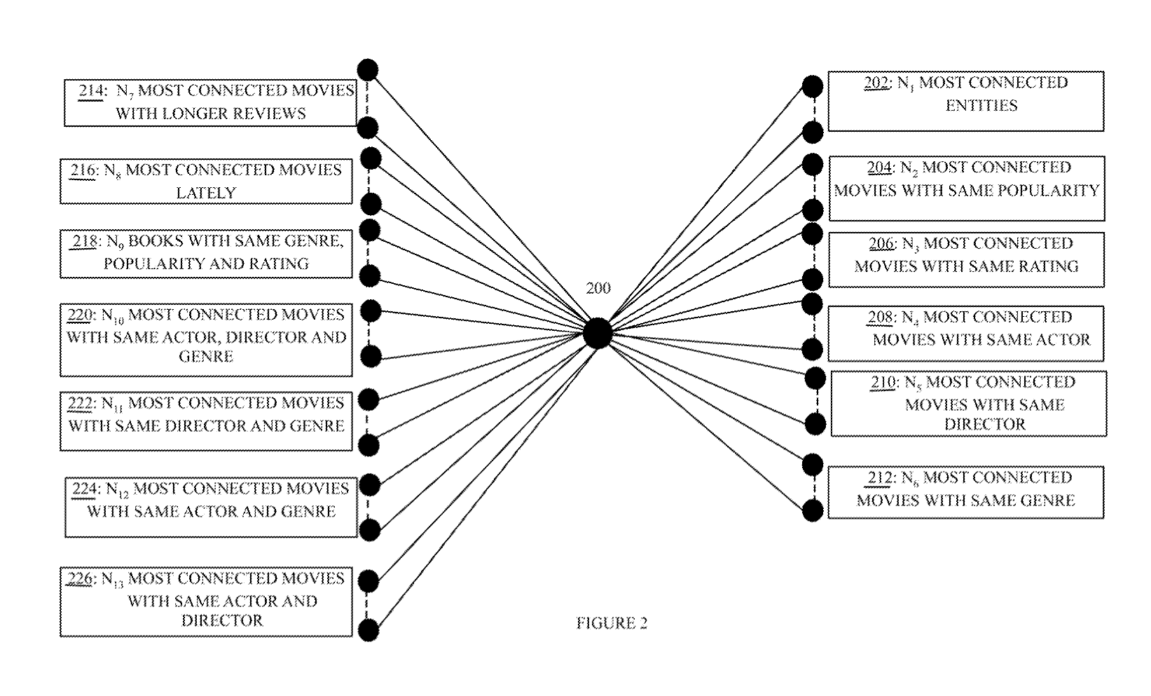

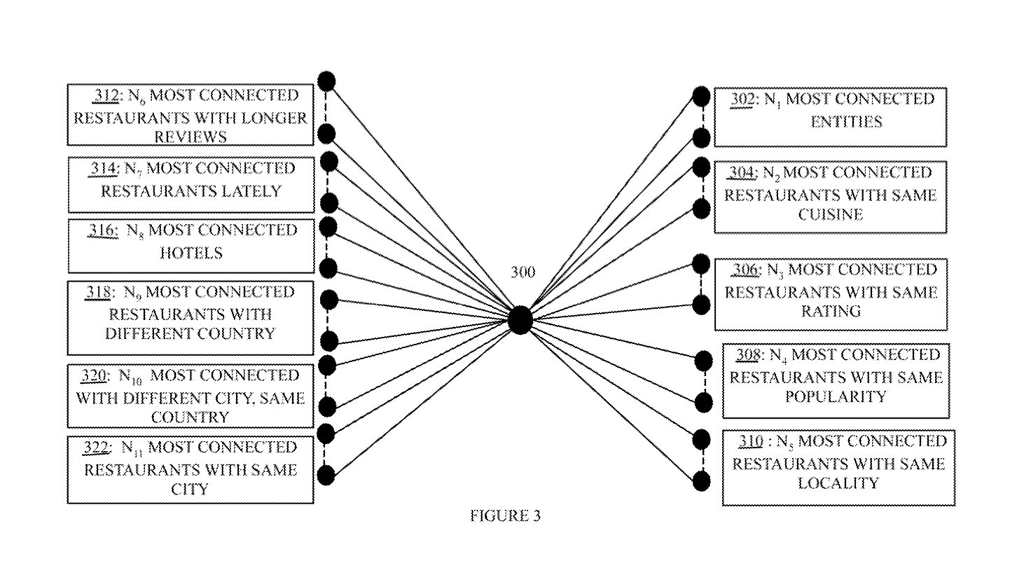

FIG. 2 and FIG. 3 illustrate taste configuration in accordance with the present invention. FIG. 2 illustrates taste configuration of entities belonging to categories of movies. Taste configurator determines entities to be connected to movie 200 as node in taste graph, depending on direct affinities calculated either from consumer behavior or from attributes. At 202, the taste configurator adds N₁ number of entities with highest direct affinity values with the movie 200 to the taste graph. At 204. N number of entities with highest direct affinity and same popularity as that of movie 200 are included. Similarly at 206, N₃ number of entities with highest direct affinity and same rating as that of movie 200 are included. Similarly, respective numbers of entities are added to the graph depending on values of direct affinities and attributes in common with the movie 200, as illustrated by 208 to 226. The numbers N₁ to N₁₃ also represent the weight assigned to each type of attribute. Higher the number Nᵢ (where i=1 to 13), higher is the weight for that particular attribute (or set of attributes). The numbers N₁ to N₁₃ could be predefined by the recommender system. Further, the taste configurator could also add entities from other categories, based on common attributes. For example, at 218, N₉ number of books with same genre, popularity and rating as that of the movie 200 are added to the taste graph. Similarly, entities from other categories could also be added to the taste graph depending on the attributes or their respective direct affinities.

FIG. 3 illustrates taste configuration for entities in category of restaurants. Taste configurator determines entities to be connected to restaurant 300 as node in the taste graph, depending on direct affinities calculated from consumer behavior or attributes. At 302, the taste configurator adds N₁ most connected entities to the restaurant 300. At 304, N₂ most connected restaurants with same cuisine as those of restaurant 300 are added. At 306, N₃ most connected restaurants with same rating as those of restaurant 300 are added. Similarly, respective numbers of entities are added to the graph depending on value of direct affinity and attributes in common with the restaurant 300, as illustrated by 308 to 322.

Although FIG. 2 and FIG. 3 illustrate taste configuration for only two categories of entities, it should be noted that similar taste configuration could be performed for all categories of entities using different attributes.

Taste configuration ensures that the taste graph adds nodes that may not have very high direct affinities, but have specific attributes in common with the nodes. Taste configuration enables better modeling of the taste graph and captures behavior of users in an optimized manner by taking into account the values of direct affinity as well as the attributes in common. It also tries to overcome constraints of location, availability of data with respect to the entities and includes entities that could potentially be of high relevance because of the common attributes.

After the taste configuration is complete, the processing device 130 scales up/down the values of direct affinities. The range and average values of direct affinities between all pairs of entities would be very different, which, unknowing to the user, would bias the choices for recommendation. To remove this bias, the taste configurator further scales values of direct affinities between all pairs of entities. Following formula could be used to scale the direct affinities to the same level:

$$Scaled affinity = \frac{Direct Affinity}{Average of all affinities} \times 1000$$

In addition, the top most and bottom most outliers with very high and very low values respectively are removed in order to remove averaging biases. After determining scaled affinity values between entities, taste graph is created with entities as nodes and scaled affinity between them as edges.

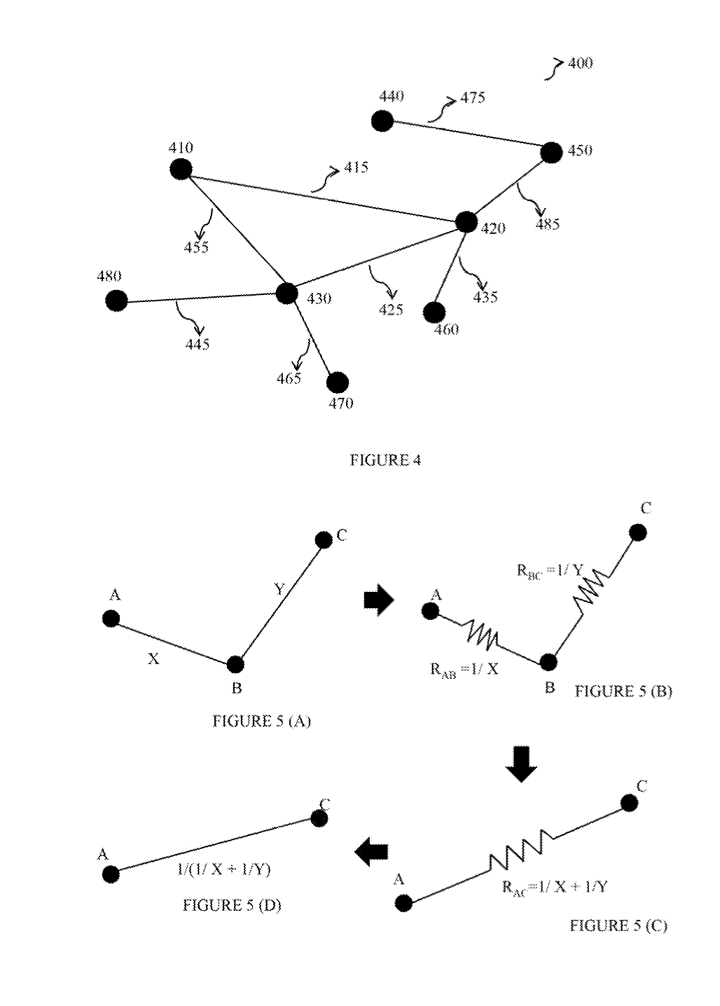

FIG. 4 illustrates taste graph 400 in accordance with the present invention. Entities are marked as nodes 410, 420, 430, 440, 450, 460, 470, 480 in the taste graph 400. These nodes could represent entities from different categories. The scaled affinity between respective nodes is represented by edges, 415, 425, 435, 445, 455, 465, 475. For example, scaled affinity between entities represented by nodes 410 and 420 is represented as edge 415 between these two nodes. According to one embodiment of the invention, the number of nodes in the taste graph may be limited and predetermined. Further, maximum number of nodes to be connected to a node may also be limited and predetermined. Also, a threshold could be set for minimum value of direct affinity for a node to be added to the taste graph.

After creating the taste graph with entities as nodes and scaled affinities between them as edges, the processing device 130 determines net affinity between any two nodes in the taste graph, using a net affinity algorithm.

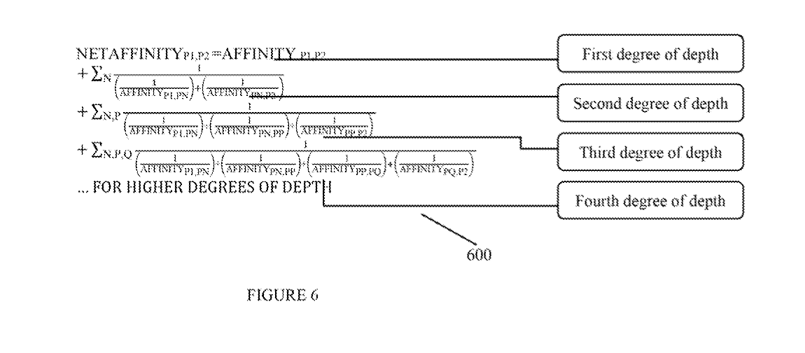

FIGS. 5 A-D illustrates net affinity algorithm in accordance with the present invention. The net affinity algorithm implements the electrical circuit analogy in the taste graph. It simulates the taste graph by simulating the edges between nodes as resistance in the electrical circuit. This implies that the affinity between the nodes is estimated as the strength of conductivity between the two nodes. FIG. 5(A) illustrates an affinity graph with nodes A, B and C. Affinity between nodes A and B is x and affinity between nodes B and C is y. There is no direct affinity between nodes A and C. This means that the raw data does not provide any information to determine affinity between nodes A and C. However, the nodes A and C could be indirectly associated through intermediate node B. As shown in FIG. 5 (B), in accordance with electrical circuit analogy for the taste graph, the affinity x between nodes A and B is represented as resistance of measure 1/x. Similarly, affinity between B and C is represented as resistance of measure 1/y. Now, effective resistance between nodes A and C can be calculated to be equal to (1/x+1/y), as shown in FIG. 5(C), according to electrical circuit topology. The effective resistance between nodes A and C represents net affinity 1/(1/x+1/y), between the nodes A and C, as shown in FIG. 5(D). Similarly, net affinity is calculated between all pairs of nodes in the taste graph. The analysis could be one degree or two degree or higher degree depending on the number of intermediate nodes between the two nodes. This net affinity is known as a taste score between the pairs of nodes.

FIG. 6 further describes the net affinity calculation 600 in accordance with the present invention. The taste graph may contain various nodes ‘P₁’, ‘P₂’, ‘Pₙ’, ‘Pₚ’ and ‘P_{q}’ and nodes ‘P₁’ and ‘P₂’ are connected with each other directly, via the node ‘Pₙ’, via the node ‘Pₚ’ and via the node ‘P_{q}’. The nodes ‘P₁’, ‘P₂’, ‘Pₙ’, ‘Pₚ’ and ‘P_{q}’ may represent the entities and the connections between any two nodes may represent the scaled affinity value, respectively. The net affinity between the two entities i.e. nodes ‘P₁’ and ‘P₂’ may be calculated with various degrees of depth as follows:

The net affinity between the nodes ‘P₁’ and ‘P₂’ (which are connected to each other directly i.e. a first degree of depth) may be calculated using the following formula, as shown in FIG. 6:

NetAffinity_{p1,p2}=Affinity_{p1,p2}

The net affinity between the nodes ‘P₁’ and ‘P₂’ (which are connected via node ‘Pₙ’ i.e. a second degree of depth) may be calculated using the following formula, as shown in FIG. 6:

$${NetAffinity}_{P 1 , P 2} = {Affinity}_{P 1 , P 2} + {\sum }_{n} \frac{1}{( \frac{1}{{Affinity}_{P 1 , Pn}} ) + ( \frac{1}{{Affinity}_{Pn , P 2}} )}$$

wherein n represents the number of nodes present in the taste graph and ‘Pₙ’ represents n^{th} node in the taste graph.

The net affinity between the nodes ‘P₁’ and ‘P₂’ (which are connected via the node ‘Pₙ’ and a node ‘Pₚ’ i.e. a third degree of depth) may be calculated using the following formula, as shown in FIG. 6:

$${NetAffinity}_{P 1 , P 2} = {Affinity}_{P 1 , P 2} + {\sum }_{n} \frac{1}{( \frac{1}{{Affinity}_{P 1 , Pn}} ) + ( \frac{1}{{Affinity}_{Pn , P 2}} )} + {\sum }_{n , p} \frac{1}{( \frac{1}{{Affinity}_{P 1 , Pn}} ) + ( \frac{1}{{Affinity}_{Pn , Pp}} ) + ( \frac{1}{{Affinity}_{Pp , P 2}} )}$$

wherein ‘Pₚ’ represents a first intermediate node.

The net affinity between the nodes ‘P₁’ and ‘P₂’ (which are connected via the node ‘Pₙ’, the node ‘Pₚ’ and a node ‘P_{q}’ i.e. a fourth degree of depth) may be calculated using the following formula, as shown in FIG. 6:

$${NetAffinity}_{P 1 , P 2} = {Affinity}_{P 1 , P 2} + {\sum }_{n} \frac{1}{( \frac{1}{{Affinity}_{P 1 , Pn}} ) + ( \frac{1}{{Affinity}_{Pn , P 2}} )} + {\sum }_{n , p} \frac{1}{( \frac{1}{{Affinity}_{P 1 , Pn}} ) + ( \frac{1}{{Affinity}_{Pn , Pp}} ) + ( \frac{1}{{Affinity}_{Pp , P 2}} )} + {\sum }_{n , p , q} \frac{1}{\begin{matrix}( \frac{1}{{Affinity}_{P 1 , Pn}} ) + ( \frac{1}{{Affinity}_{Pn , Pp}} ) + \\ ( \frac{1}{{Affinity}_{Pp , Pq}} ) + ( \frac{1}{{Affinity}_{Pq , P 2}} )\end{matrix}} ,$$

wherein ‘P_{q}’ represents a second intermediate node.

According to another aspect of the invention, the net affinity between two nodes is known as taste score between the two corresponding entities. The taste scores determined using the net affinity algorithm are exported to a taste table. The taste table illustrates taste scores between two entities in a tabular format. Following is an example of taste table with a three entities in accordance with the invention:

TABLE 1

| | | Taste score between |
|---|---|---|
| Entity 1 | Entity 2 | Entity 1 and Entity 2 |
| A | B | 150 |
| B | C | 250 |
| A | C | 200 |

Table 1 illustrates taste scores between pairs of entities. For example, taste score between entities A and B is 150.

According to another aspect of the invention, the customer input device 140 in FIG. 1 receives user input. The user input could include context information, behavior information, prioritizing filters and feedback on recommendation results. Context related user input may include one or more input related to current location, target location, date, time, weather, person accompanying the user, category of entity etc. Behavior related user input may include one or more input related to age, gender, preferences, social media likes, reviews, past purchase behavior, feedback on previous recommendations, etc. Behavior related user input could be obtained from user's profile on social media websites such as Facebook, Twitter. LinkedIn etc. Personalized filters enable user to select specific attributes, category or limit on the number of recommended choices. For example, the user could select the genre, year of release, actor or director of desired movies for recommendation. Similarly, the user could select the cuisine or type of restaurant desired for recommendation. Further, the user could select certain desired attributes in the recommended choices. User could further input feedback on choices recommended by the recommender system. The feedback could be positive or negative in nature, depending on relevance of the recommended choices.

The user input is required by the recommender system for determining user's taste and context in order to determine most relevant, personalized choices for recommendation.

After receiving the user input, the processing device 130 generates scores for each entity, depending on the user input. Different scores are generated for each entity, the scores comprising at least one of scores relevant to location, accompany, date/time, preference, social media, segment, feedback, attributes etc. These scores are measures of relevance of each entity to the user, depending upon the user's context and behavior. For example, score relevant to accompany, also known as an accompany score, is a measure of relevance of an entity such as hotel or restaurant depending on who is accompanying the user. Similarly, score relevant to location, also known as a location score, is a measure of relevance of a hotel or restaurant depending on user's location. A restaurant closer to user's location would get a higher score in comparison to a restaurant that is far away from user's location. Preference score is measure of relevance of an entity such as book, movie or product, depending on user's preferences. Scores such as accompany score, weather score, location score and data/time score are related to the context of user. Scores such as preference score, social media score, segment score and feedback score are related to user's behavior. These scores may be generated based on heuristics models and taste graphs.

Further, different weights are assigned to each of these scores by a choice configurator. The choice configurator could be a part of processing device 130. The choice configurator determines weights to be assigned to each score among accompanied by score, location score, date/time score, preference score, social media score, segment score, feedback score, attribute score etc. Further, the choice configurator calculates a net score for each entity using these scores. For example, the net score could be a determined by the following formula:

Net score=attribute scoreⁿ×[(Preference score+social media score+feedback score)^{a}×(location score)^{b}×(accompanied by score)^{c}×(date/time score)^{d}]

wherein a, b, c, d and n are weights assigned by the choice configurator for the respective scores.

After determining the net score for each entity, the processing device 130 determines a limited number of entities with highest net scores. These entities are then recommended to the user in form of choices by output device 150. The choices could be displayed on the output device 150 in decreasing order of values of net scores. The number of choices to be recommended could be limited by the user or by the merchant. The output device 150 could further display details of the recommended choices. The details could include a list of attributes that match the attributes in user's tastes, list of attributes that match the attributes in user's prioritizing filters, additional attributes of the recommended choices. The details could further include a graph that graphically illustrates a comparison of user's inputs and recommended choices.

After the choices are delivered to the user, the recommender system takes feedback from the user using the customer input device 140. The recommender system learns automatically from the user feedback on past recommendations. The user could provide negative or positive feedback to the recommendation system depending on relevance of the recommended choices. When the system receives a positive feedback, it interprets that taste, attributes, preferences used for determining the prospects was optimum and takes this taste, attributes, preferences into consideration for future recommendations to the user. On the other hand, when it receives a negative feedback, it re-examines the taste, attributes, preferences and modifies them so as to provide better recommendations in future to the user. Thus, the recommender system automatically learns to choose more relevant attributes, preferences and taste for recommending choices, depending on the user feedbacks.

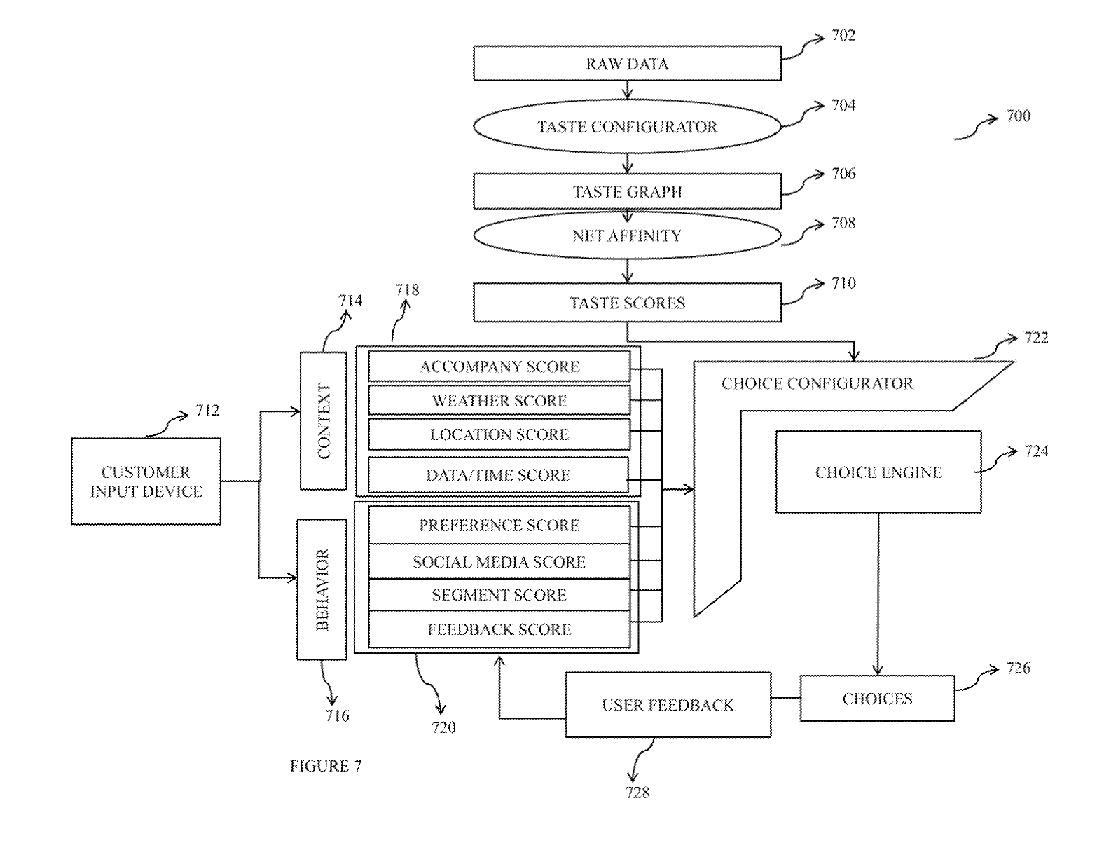

FIG. 7 illustrates the embodiment of the present invention, 700 with choice configurator 722 and user feedback 728 in association with other parts of the present invention. At step 702, raw data is received from various internal and external sources. The raw data is structured and taste configurator 704 configures a taste graph from the structured data, in accordance with embodiments disclosed in FIG. 2 and FIG. 3. At step 706, taste graph is created in accordance with embodiments disclosed in FIG. 4. At step 708, net affinity algorithm is used to determine net affinity between any two nodes in the taste graph, in accordance with embodiments disclosed in FIG. 5. At step 710, a taste table is created to represent pairs of entities and their respective net affinity (also known as taste score). Now, the customer input device 712 receives user input. User input comprises of context data input 714 and behavior data input 716. Context data input 714 comprises of input related to user's location, date/time, weather and accompaniment. Behavior data input 716 comprises of input related to user's preference, social media likes, desired segment of entities and feedback on previous recommendations. Each of these user inputs is used to determine scores for each entity in the taste graph. 718 illustrates context related scores, i.e. accompany score, weather score, location score and date/time score. 720 illustrates behavior related scores, i.e. preference score, social media likes score, segment score and feedback score. These scores are then provided to choice configurator 722 and respective weights for each of these scores are determined. The scores and their respective weights are provided to the choice engine 724. The choice engine calculates net score for each entity depending on the weights of each score. A limited number of entities with highest net score values are then recommended to the user as choices in step 726. After receiving the recommended choices, the user provides feedback at step 728. The feedback provided by the user is used by the recommender system for future recommendations to the user.

According to one aspect of the invention, the recommender system 700 is used by a merchant for recommending choices to the customers. The merchant could be a credit card provider, retailer, e-commerce retailer, telecom service provider or hospitality service provider. The merchant could determine rules for taste configuration of the taste graph. The merchant could also assign weights for user input scores in choice configurator 722, disclosed in FIG. 7. Further, the merchant could impose limit on the number of choices to be recommended to the customer. The merchant could also limit the recommendations to certain categories of entities. The customers could be current or potential customers of the merchant. Further, the customers could input context and behavior data input through merchant's website or mobile device software application for providing user input. Recommended choices could be delivered to the user in form of mailers, text message, SMS, email or through merchant's website or software application running on customer's mobile device.

According to one aspect of the invention, recommender system 700 disclosed in FIG. 7 is used in hospitality industry for recommending restaurants as choices to customers staying in hotels. Customer reviews on restaurants and social media likes related to restaurants are received as raw data. Further, taste graph is created with restaurants as nodes and respective affinities between them as edges. Net affinity algorithm implementing electrical circuit analogy is then used to determine net affinity scores or taste scores between all pairs of restaurants. Customer provides the restaurants he/she likes as input. The restaurants input by the customer may be located at customer's home city or other places not in the vicinity of the hotel. Further, customer also inputs his/her preferences or desired attributes for the restaurants. Customer's feedback, accompany details, social media information, weather, location, date and time could also be received as input, given his/her explicit permissions. Scores are then determined for each user input information set and for each restaurant in the taste graph. Net scores are calculated for each restaurant using the scores of each input information set. The recommender system 700 then recommends restaurants as choices to the customer in decreasing order of net scores.

According to another aspect of the invention, recommender system 700 disclosed in FIG. 7 is used in banking industry for recommending merchants as choices to bank's customers. Credit card transaction data related to merchants is received as raw data. Further, taste graph is created with merchants as nodes and respective affinities between them as edges. Net affinity algorithm implementing electrical circuit analogy is then used to determine net affinity scores or taste scores between all pairs of merchants. Credit card transactions of customer are received as customer input. Further, customer also provides his/her preferences or desired attributes along with social media information, location, date and time as input. Scores are then determined for each user input information set and for each merchant in the taste graph. Net scores are calculated for each merchant using the scores of each input information set. The recommender system 700 then recommends merchants or deals offered by merchants as choices to the customer in decreasing order of net scores.

According to another aspect of the invention, the recommender system 700 disclosed in FIG. 7 is used in telecom industry for recommending media items for download to the customers. Consumer browsing history in form of cookies is received as raw data by the recommender system 700. Further, taste graph is created with media items as nodes and respective affinities between them as edges. Net affinity algorithm implementing electrical circuit analogy is then used to determine net affinity scores or taste scores between all pairs of media items in the taste graph. Browsing history or media purchase history of customer is received as customer input. Further, customer also provides his/her media preferences or desired attributes along with social media information, location, date and time as input. Scores are then determined for each user input information set and for each media item in the taste graph. Net scores are calculated for each merchant using the scores of each input information set. The recommender system 700 then recommends media items as choices to the customer in decreasing order of net scores.

According to another aspect of the invention, the recommender system 700 disclosed in FIG. 7 is used in retail industry by retailers for recommending products to the customers. Consumer loyalty cards and sales invoices of retailer are received as raw data input. Further, taste graph is created with products offered by retailer as nodes and respective affinities between them as edges. The edges could be of three types such as non-directed, directed and temporal affinities. Net affinity algorithm implementing electrical circuit analogy is then used to determine net affinity scores or taste scores between all pairs of products in the taste graph. Customer's past transactions, browsing history are obtained as customer input. Further, customer also provides items in his/her shopping cart, his/her taste preferences or desired product categories along with social media information, location, date and time as input. Scores are then determined for each user input information set and for each product in the taste graph. The recommender system 700 then recommends products as choices to customer in decreasing order of net scores.

The recommender system in accordance with the present invention can also be used by media companies for recommending TV shows to users, consumer companies for recommending lifestyle choices to customers or by advertising companies for providing personalized and relevant advertisements to customers.

The recommender system in accordance with the present invention is capable of learning and improving its configuration automatically, without human intervention. The system is configured to improvise itself by incorporating empirical data from various data sources and is configured to automatically learn to recognize complex patterns and make intelligent decisions based on the empirical data from various data sources. The empirical data sources could be the data sources based on customer feedbacks, logs resulting from usage of the proposed recommendation system or additional available user data in the existing data sources. The system is thus machine learned and learns automatically from the user feedbacks on recommendation results.

The embodiments in accordance with the present invention can be implemented with any combination of hardware and software. If implemented as a computer-implemented apparatus, the present invention can be implemented using means for performing all of the steps and functions described above.

Although the description above illustrates the present invention with many specific examples, these should not be construed as limiting the scope of the invention but as merely illustrating some of the presently preferred embodiments of this invention.

Thus, the scope of the invention should be determined by the appended claims and any and all equivalents thereof, rather than by the examples given. It should be understood that various changes and substitutions could be made herein without departing from the spirit and scope of the invention.

What is claimed as new and desired to be protected by Letters Patent of the United States is:

1. A method for recommending limited, personalized and relevant choices to a customer in real-time, the method comprising:
receiving data in relation to various categories of entities from various data sources;
transforming the received data into structured data to determine affinities between pairs of entities;
configuring a taste graph with entities as nodes and associated affinity between them as edges;
calculating net affinity scores between all pairs of entities in the taste graph;
exporting the net affinity scores as taste scores to a taste table;
receiving customer input in form of context and behavior information sets;
generating a plurality of scores for each entity based on the customer input information sets;
determining weights for the plurality of scores and calculate a net score for each entity based on the plurality of scores of the entity; and
recommending a list of entities as choices to customer based on descending order of values of the net scores.

2. The method as claimed in claim 1, wherein the different categories of entities comprise one or more of books, movies, restaurants, hotels, music, shopping, television shows or events and deals.

3. The method as claimed in claim 1, wherein the received data comprises one or more of data related to sales and transactions, social media statistics, consumer and expert reviews, loyalty programs, consumer browsing behavior and product information.

4. The method as claimed in claim 1, wherein the net affinity between any two products is calculated using a graph traversing methodology.

5. The method as claimed in claim 1, wherein the input context information set comprises one or more of location data, weather data, accompany data, date/time data related to the customer.

6. The method as claimed in claim 1, wherein the input behavior information set comprises one or more of age data, gender data, social media data, preferences data, review data, transactions data, feedback data and attributes data related to the customer.

7. The method as claimed in claim 1, wherein the scores based on customer information sets comprise one or more of accompany score, weather score, location score, data/time score, preference score, social media score, attribute score, segment score and feedback score.

8. The method as claimed in claim 1, wherein the scores based on customer information sets are generated based on heuristics models and the taste graph.

9. The method described in claim 1 is further configured to learn from customer feedbacks, wherein the system automatically learns to choose more relevant choices for recommendation depending on the user feedbacks.

10. A system for recommending limited, personalized and relevant choices to a customer in real-time, the system comprising:
a data receiving device for receiving data in relation to various categories of entities from various data sources;
a customer input receiving device for receiving customer input in form of context and behavior information sets;
at least one processor coupled to a memory, the processor executes an algorithm for:
transforming the received data into structured data to determine affinities between pairs of entities;
configuring a taste graph with entities as nodes and associated affinity between them as edges:
calculating net affinity scores between all pairs of entities in the taste graph;
exporting the net affinity scores taste scores to a taste table:
generating a plurality of scores for each entity based on the customer input information sets;
determining weights for the plurality of scores and calculate a net score for each entity based on the plurality of scores of the entity; and
selecting a list of entities as choices for recommendation based on descending order of values of the net scores:
an output device to display the list of choices for recommendation to the customer.

11. The system as claimed in claim 10, wherein the different categories of entities comprise one or more of books, movies, restaurants, hotels, music, shopping, television shows or events and deals.

12. The system as claimed in claim 10, wherein the received data comprises one or more of data related to sales and transactions, social media statistics, consumer and expert reviews, loyalty programs, consumer browsing behavior and product information.

13. The system as claimed in claim 10, wherein the net affinity between any two products is calculated using a graph traversing methodology.

14. The system as claimed in claim 10, wherein the input context information set comprises one or more of location data, weather data, accompany data, date/time data related to the customer.

15. The system as claimed in claim 10, wherein the input behavior information set comprises one or more of age data, gender data, social media data, preferences data, review data, transactions data, feedback data and attributes data related to the customer.

16. The system as claimed in claim 10, wherein the scores based on customer information sets comprise one or more of accompany score, weather score, location score, data/time score, preference score, social media score, attribute score, segment score and feedback score.

17. The system as claimed in claim 10, wherein the scores based on customer information sets are generated based on heuristics models and the taste graph.

18. The system as claimed in claim 10 is further configured to learn from customer feedbacks, wherein the system automatically learns to choose more relevant choices for recommendation depending on the user feedbacks.

19. A non-transitory computer medium configured to store executable program instructions, which, when executed by an apparatus, cause the apparatus to perform the steps of:
receiving data in relation to various categories of entities from various data sources;
transforming the received data into structured data to determine affinities between pairs of entities;
configuring a taste graph with entities as nodes and associated affinity between them as edges;
calculating net affinity scores between all pairs of entities in the taste graph;
exporting the net affinity scores as taste scores to a taste table;
receiving customer input in form of context and behavior information sets;
generating a plurality of scores for each entity based on the customer input information sets;
determining weights for the plurality of scores and calculate a net score for each entity based on the plurality of scores of the entity; and
recommending a list of entities as choices to customer based on descending order of values of the net scores.
